(19) United States
(12) Patent Application Publication
(10) Pub. No.: US 2026/0029548 A1
(43) Pub. Date: Jan. 29, 2026

(54) SYSTEM AND METHOD FOR PERFORMING A GLOBAL NAVIGATION SATELLITE SYSTEM (GNSS) MEASUREMENT IN NON-TERRESTRIAL NETWORK (NTN)

(71) Applicant: Apple Inc., Cupertino, CA (US)

(72) Inventors: Chunhai Yao, Beijing (CN); Chunxuan Ye, San Diego, CA (US); Hong He, San Jose, CA (US); Dawei Zhang, Saratoga, CA (US); Wei Zeng, Saratoga, CA (US); Ankit Bhamri, Haar-Bavaria (DE); Haitong Sun, Saratoga, CA (US); Huaning Niu, San Jose, CA (US); Sigen Ye, San Diego, CA (US); Seyed Ali Akbar Fakoorian, San Diego, CA (US)

(21) Appl. No.: 18/997,073

(22) PCT Filed: Aug. 10, 2022
(86) PCT No.: PCT/CN2022/111473

§ 371 Date: Jan. 18, 2025

(51) Int. Cl. G01S 19/46; H04W 56/00; H04W 72/231; H04W 76/20

(52) U.S. Cl. CPC G01S 19/46; H04W 56/0045; H04W 72/231; H04W 76/20

(57) ABSTRACT

The disclosure relates to a system and a method for performing a Global Navigation Satellite System (GNSS) measurement in Non-terrestrial network (NTN). In some aspects, a user equipment (UE) may comprise: at least one antenna; at least one radio, configured to perform wireless communication using at least one radio access technology; and one or more processor coupled to the at least one radio, wherein the at least one radio and the one or more processor are configured to cause the UE to detect an event to trigger a Global Navigation Satellite System (GNSS) measurement; transmit, to a network device, a request to perform an event-triggered GNSS measurement, in response to detection of the event; receive, from the network device, a configuration for an event-triggered GNSS measurement gap during which the UE performs the event-triggered GNSS measurement in a connected state; and perform the event-triggered GNSS measurement in the connected state during the event-triggered GNSS measurement gap.

### TECHNICAL FIELD

This application relates generally to wireless communication systems, including performing a Global Navigation Satellite System (GNSS) measurement in Non-terrestrial network (NTN).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

In some cases, the wireless communication system may comprise one or more satellites which may relay signals or act as base stations, such as in the NTN. On the other hand, the GNSS measurement has been proposed to be supported in the NTN. Thus, there is a need for techniques for performing a GNSS measurement in NTN.

### SUMMARY

In some aspects, a user equipment may comprise: at least one antenna; at least one radio, configured to perform wireless communication using at least one radio access technology; and one or more processors coupled to the at least one radio, wherein the at least one radio and the one or more processors are configured to cause the UE to: transmit, to a network device, GNSS measurement related information which includes a GNSS measurement gap during which the UE performs a GNSS measurement in a connected state; receive a configuration for the GNSS measurement gap from the network device, wherein the configuration for the GNSS measurement gap comprises a periodicity with which the GNSS measurement gap is repeated; and perform the GNSS measurement in the connected state during the GNSS measurement gap with the periodicity.

According to some aspects, the UE may request an updated configuration for the GNSS measurement gap modified by the network device; receive the updated configuration for the GNSS measurement gap; and perform an updated GNSS measurement in the connected state during the updated GNSS measurement gap.

In some aspects, a user equipment may comprise: at least one antenna; at least one radio, configured to perform wireless communication using at least one radio access technology; and one or more processors coupled to the at least one radio, wherein the at least one radio and the one or more processors are configured to cause the UE to: detect an event to trigger a GNSS measurement; transmit, to a network device, a request to perform an event-triggered GNSS measurement, in response to detection of the event; receive, from the network device, a configuration for an event-triggered GNSS measurement gap during which the UE performs the event-triggered GNSS measurement in a connected state; and perform the event-triggered GNSS measurement in the connected state during the event-triggered GNSS measurement gap.

In some aspects, a non-transitory computer readable memory medium may store program instructions executable by one or more processor to cause the UE to: detect an event to trigger a GNSS measurement; transmit, to a network device, a request to perform an event-triggered GNSS measurement, in response to detection of the event; receive, from the network device, a configuration for an event-triggered GNSS measurement gap during which the UE performs the event-triggered GNSS measurement in a connected state; and perform the event-triggered GNSS measurement in the connected state during the event-triggered GNSS measurement gap.

In some aspects, a method may comprise: detecting an event to trigger a GNSS measurement; transmitting, to a network device, a request to perform an event-triggered GNSS measurement, in response to detection of the event; receiving, from the network device, a configuration for an event-triggered GNSS measurement gap during which the UE performs the event-triggered GNSS measurement in a connected state; and performing the event-triggered GNSS measurement in the connected state during the event-triggered GNSS measurement gap.

In some aspects, a network device may comprise: at least one antenna; at least one radio, configured to perform wireless communication using at least one radio access technology; and one or more processors coupled to the at least one radio, wherein the at least one radio and the one or more processors are configured to cause the network device to: detect an event to trigger a GNSS measurement for a UE; schedule a configuration for an event-triggered GNSS measurement gap for the UE to perform an event-triggered GNSS measurement in a connected state during the event-triggered GNSS measurement gap, in response to detection of the event; and transmit the configuration for the event-triggered GNSS measurement gap to the UE.

In some aspects, a non-transitory computer readable memory medium may store program instructions executable by one or more processor to cause a network device to: detect an event to trigger a GNSS measurement for a UE; schedule a configuration for an event-triggered GNSS measurement gap for the UE to perform an event-triggered GNSS measurement in a connected state during the event-triggered GNSS measurement gap, in response to detection of the event; and transmit the configuration for the event-triggered GNSS measurement gap to the UE.

In some aspects, a method may comprise: detecting an event to trigger a GNSS measurement for a UE; scheduling a configuration for an event-triggered GNSS measurement gap for the UE to perform an event-triggered GNSS measurement in a connected state during the event-triggered GNSS measurement gap, in response to detection of the event; and transmitting the configuration for the event-triggered GNSS measurement gap to the UE.

In some aspects, a user equipment may comprise: at least one antenna; at least one radio, configured to perform wireless communication using at least one radio access technology; and one or more processors coupled to the at least one radio, wherein the at least one radio and the one or more processors are configured to cause the UE to: receive a configuration for a Radio Link Failure (RLF) procedure, wherein the configuration comprises a threshold which represents a maximum allowable number for Out-of-Sync indications and a timer used for radio link failure and recovery, and wherein the timer has a time period accounted for a GNSS measurement; detect whether a number of the Out-of-Sync indications reaches the threshold; in response to the detection that the number of the Out-of-Sync indications reaches the threshold, start the timer; and perform the GNSS measurement during the RLF procedure.

In some aspects, a user equipment may comprise: at least one antenna; at least one radio, configured to perform wireless communication using at least one radio access technology; and one or more processors coupled to the at least one radio, wherein the at least one radio and the one or more processors are configured to cause the UE to: receive an indication that a network device supports enhanced time or frequency control from the network device; report a capability of the UE for supporting enhanced time or frequency control to the network device, in response to receipt of the indication; and transmit, a first GNSS validity duration which indicates a GNSS validity duration when the enhanced time or frequency control is applied, and a second GNSS validity duration which indicates a GNSS validity duration when the enhanced time or frequency control is not applied, to the network device.

The techniques described herein may be implemented in and/or used with a number of different types of devices, including but not limited to cellular base stations, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example of procedures of the GNSS measurement in NTN, according to embodiments disclosed herein.

FIG. 4 is a flowchart diagram illustrating an example method for performing a periodic GNSS measurement, by a UE, according to embodiments disclosed herein.

FIG. 5 is a flowchart diagram illustrating an example method for performing an updated GNSS measurement, by a UE, according to embodiments disclosed herein.

FIG. 6 is a flowchart diagram illustrating an example method for performing an event-triggered GNSS measurement, by a UE, according to embodiments disclosed herein.

FIG. 7 is a flowchart diagram illustrating an example method for performing an event-triggered GNSS measurement, by a network device, according to embodiments disclosed herein.

FIG. 8 is a flowchart diagram illustrating an example method for performing a GNSS measurement in RLF procedure, by a UE, according to embodiments disclosed herein.

FIG. 9 is a flowchart diagram illustrating an example method for a GNSS measurement in enhanced time or frequency control, by a UE, according to embodiments disclosed herein.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IoT) device, or a machine type communications (MTC) device, among other examples, which may be implemented in various objects such as appliances, or vehicles, meters, among other examples.

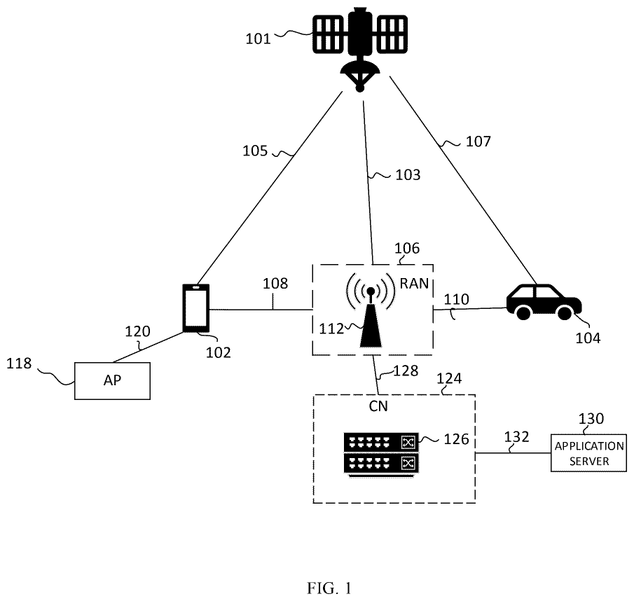

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes a satellite 101, UE 102 and UE 104 (although any number of UEs may be used), and base station 112. In this example, the UE 102 is illustrated as smartphone (e.g., handheld touchscreen mobile computing devices connectable to one or more cellular networks) and the UE 104 is illustrated as a vehicle, but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers. In some embodiments, all or parts of the base station 112 may be implemented as one or more software entities running on server computers as part of a virtual network.

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an SI interface 128. In embodiments, the SI interface 128 may be split into two parts, an S1 user plane (S1-U) interface, which carries traffic data between the base station 112 and a serving gateway (S-GW), and the S1-MME interface, which is a signaling interface between the base station 112 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 and a user plane function (UPF), and the SI control plane (NG-C) interface, which is a signaling interface between the base station 112 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VolP sessions, group communication sessions, etc.) for the UE 102 and UE 104 via the CN 124. The application server 130 may communicate with the CN 124 through an IP communications interface 132.

In embodiments, the satellite 101 may communicate with base station 112 and UEs 102 and 104. Satellite 101 may be any suitable type of communication satellite configured to relay communications between different end nodes in a wireless communication system. Satellite 101 may be an example of a space satellite, a balloon, a dirigible, an airplane, a drone, an unmanned aerial vehicle, and/or the like. In some examples, the satellite 101 may be in a geosynchronous or geostationary earth orbit, a low earth orbit or a medium earth orbit. A satellite 101 may be a multi-beam satellite configured to provide service for multiple service beam coverage areas in a predefined geographical service area. The satellite 101 may be any distance away from the surface of the earth.

In embodiments, the satellite 101 may perform the functions of a base station 112, act as a bent-pipe satellite, or may act as a regenerative satellite, or a combination thereof. In other cases, satellite 112 may be an example of a smart satellite, or a satellite with intelligence. For example, a smart satellite may be configured to perform more functions than a regenerative satellite. A bent-pipe satellite may be configured to receive signals from ground stations and transmit those signals to different ground stations. A regenerative satellite may be configured to relay signals like the bent-pipe satellite, but may also use on-board processing to perform other functions. In the case of regenerative satellite, the satellite can be used as base station for the wireless communication.

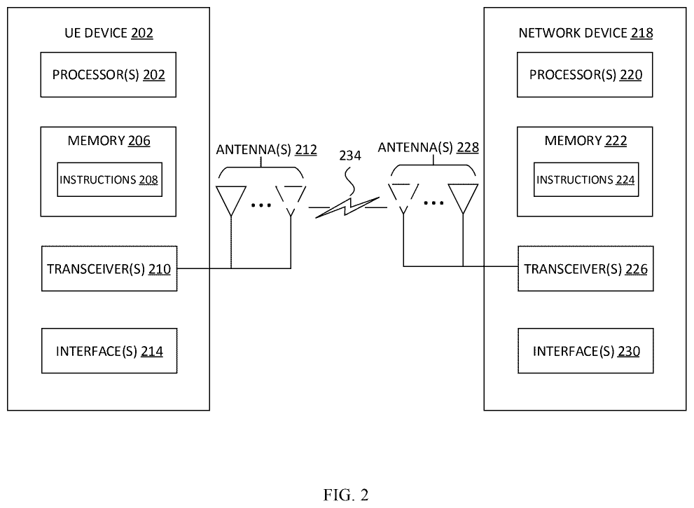

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a satellite or a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

For a wireless device 202 that is a UE, it may need to receive a position fix signal (e.g., a Global Positioning System (GPS) signal) or to know its position before accessing to and communicating with the network.

In an example case that a satellite 101 acts as the network device 218 in IoT NTN, the UE may be a low-cost device. In IoT NTN communications, the UE needs to know its position when performing an uplink synchronization and computing Timing Advance (TA). Therefore, the UE may locate its position in near real-time and then transmit data with the network. Usually, the UE may have a capability of GNSS operations including a GNSS measurement for acquiring its position fix, but cannot perform the GNSS operations and the NTN NB-IoT/eMTC/LTE operations simultaneously.

The IoT NTN mainly aims at scenarios where network construction and maintenance are inconvenient, such as maritime transportation, wilderness transportation, energy collection, agriculture and environmental protection. The NB-IoT/eMTC technology is applied to satellite communications to realize space-to-earth IoT NTN communications, supplement to existing IoT and provide support for real global coverage of the IoT. Therefore, IoT NTN performance enhancements may be beneficial. Aspects for IoT NTN performance enhancements may include disabling of a hybrid automatic repeat request (HARQ) feedback to mitigate the impact of HARQ stalling on UE data rates; improved GNSS operations for a new position fix for UE pre-compensation during long connection times and for reduced power consumption, simultaneous GNSS and NTN NB-IoT/eMTC operation is not assumed.

The UE may acquire a GNSS position fix in IDLE mode for a sporadic short transmission, which is described below. For a sporadic short transmission, an IDLE UE may wake up from the IDLE Discontinuous Reception Mode (DRX)/Power Saving Mode (PSM), accesses the network, perform uplink and/or downlink communications for a short duration of time and go back to IDLE. Before accessing the network, the UE may acquire the GNSS position fix in IDLE mode and may not need to re-acquire the GNSS position fix for the transmission of packets, since the GNSS position fix does not become outdated during the short transmission. Discussion on details of the duration of the short transmission, acquisition of the GNSS position and validity of the GNSS position may be beneficial.

Aspects related to the validity of the GNSS position may be specified: for the sporadic short transmission, the UE in RRC_CONNECTED should go back to IDLE mode and re-acquire a GNSS position fix if the GNSS position becomes outdated; the UE autonomously determines its GNSS validity duration X and reports information associated with this GNSS validity duration to the network via a Radio Resource Control (RRC) signaling, wherein possible X={10 s, 20 s, 30 s, 40 s, 50 s, 60 s, 5 min, 10 min, 15 min, 20 min, 25 min, 30 min, 60 min, 90 min, 120 min, infinity}; the GNSS validity duration of the short transmission is not longer than the “validity timer for UL synchronization”, but which still needs further discussion.

While in long connection times, the IoT NTN UE may need to re-acquire a valid GNSS position fix, since the GNSS position fix may become outdated during the long connection times. Therefore, discussion on whether and how to update or reduce the need to update the GNSS position fix in long connection times may be beneficial.

At least the following options on the GNSS measurement in connected state for potential enhancements for improved GNSS operations may be beneficial: option 1—the UE re-may acquire the GNSS position fix during the RLF procedure; option 2—the UE may re-acquire the GNSS position fix with a new gap. Currently, the IoT NTN UE is not mandated to support one or both of the options.

When performing the GNSS measurement, the UE may report GNSS related information or GNSS assistance information. Additional GNSS assistance information or detailed GNSS assistance information, including e.g., a GNSS position fix measurement time that indicates how long the GNSS measurement needs (such as, a GNSS measurement gap), may be beneficial. The GNSS validity duration X reported by the UE is introduced, which is included in the GNSS assistance information.

Potential enhancements on the UE triggered GNSS measurement and the network triggered GNSS measurement for long connection times may also be beneficial.

The disclosure will describe techniques for performing GNSS measurement in NTN. For example, the procedures of IoT UE GNSS measurement will be described, such as a configuration for periodic GNSS measurement gaps, an updating of the configuration for the GNSS measurement gaps, a configuration for event-triggered aperiodic GNSS measurement gaps from both the UE side and the network side. Besides, the procedures of the GNSS measurement in the RLF procedure, and the GNSS measurement in enhanced time and/or frequency control will be described.

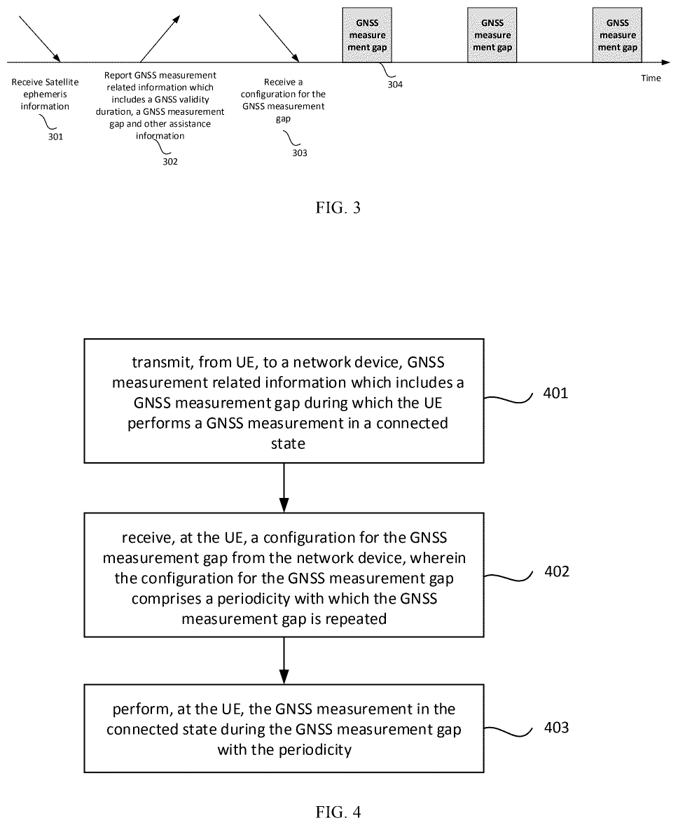

FIG. 3 illustrates an example of procedures of the GNSS measurement in NTN, according to embodiments disclosed herein. In some examples, the interaction of FIG. 3 may be between a wireless device such as a UE 102 or 104 and a network device such as a base station 112 or a gNB illustrated in various of the Figures herein.

At 301, a UE may receive, from a network, satellite ephemeris information.

At 302, the UE may report, to the network, GNSS measurement related information which includes a GNSS validity duration, a GNSS measurement gap and other assistance information.

At 303, the UE may receive, from the network, a configuration for the GNSS measurement gap.

The UE may perform the GNSS measurement during the configured GNSS measurement gaps 304. Although FIG. 3 shows an example of the configuration for GNSS measurement gaps with three GNSS measurement gaps over time, during which the GNSS measurement can be performed, those skilled in the art would understand it could be periodic, or it can be any other number which may be configured by the network.

Details of the above operations will be discussed with reference to FIG. 4.

FIG. 4 is a flowchart diagram illustrating an example method for performing a periodic GNSS measurement, by a UE, according to embodiments disclosed herein. Aspects of the method of FIG. 4 may be implemented by a wireless device such as a UE 102 or UE 104 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method of FIG. 4 may operate as follows.

At 401, the UE may transmit, to the network device, GNSS measurement related information which includes a GNSS measurement gap during which the UE performs a GNSS measurement in a connected state, such as an RRC_CONNECTED state. In some aspects, the GNSS validity duration included in the GNSS measurement related information may also by reported by the UE.

In one aspect, the GNSS measurement related information reported by the UE may further include an entry index of a GNSS measurement gap table which lists a plurality of GNSS measurement gaps. In one aspect, the GNSS measurement gap table may be configured by the network device.

In another aspect, the GNSS measurement related information reported by the UE may further include mobility information of the UE. The mobility information of the UE may include (Vx, Vy) with coarse granularity in units of m/s. The (Vx, Vy) may indicate a speed of the UE in X-axis and Y-axis.

In yet another aspect, the GNSS measurement related information reported by the UE may further include an elevation angle of the UE. For a small elevation angle, it may indicate that the satellite is far from the UE, thus a more frequent measurement gap may be needed.

In yet another aspect, the GNSS measurement related information reported by the UE may further include a remaining validity duration of a current GNSS position fix. For example, if the validity duration of a GNSS position fix is 10 s and the remaining validity duration of the GNSS position fix is 4 s, the 4 s of the remaining validity duration can also be reported by the UE.

At 402, the UE may receive, a configuration for the GNSS measurement gap, from the network device. In one aspect, the configuration for the GNSS measurement gap may comprise a periodicity with which the GNSS measurement gap is repeated.

In another aspect, the configuration for the GNSS measurement gap may further include a starting time of a first GNSS measurement gap and a GNSS measurement gap duration.

The GNSS measurement gap duration may be represented by an entry index of a GNSS measurement gap duration table which lists a plurality of GNSS measurement gap durations, the GNSS measurement gap duration table may be configured by the network device.

A value of the GNSS measurement gap duration of 0 can be supported. For example, the value of 0 may indicate a static UE which does not need GNSS measurement gap at all, or it may indicate a future UE with the capability of performing the GNSS measurement and LTE operation simultaneously.

In one aspect, the configuration for the GNSS measurement gap may be received via an RRC signaling.

At 403, the UE may perform, the GNSS measurement in the connected state during the GNSS measurement gap with the periodicity. Examples of GNSS measurement gap can be seen with reference to FIG. 3. In one aspect, during the configured GNSS measurement gap, the UE does not perform data transmissions/receptions with the network.

Due to some reasons, the configuration for the GNSS measurement gap may be updated or modified.

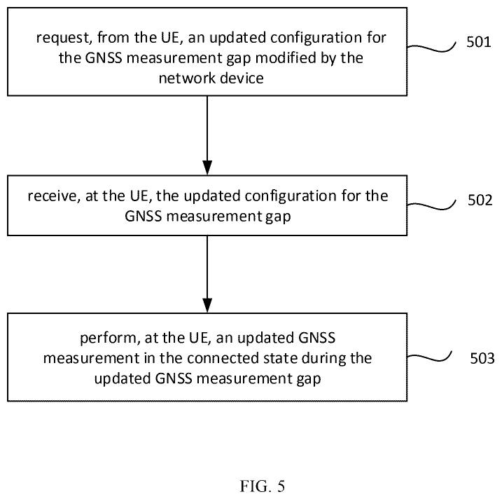

FIG. 5 is a flowchart diagram illustrating an example method for performing an updated GNSS measurement, by a UE, according to embodiments disclosed herein. Aspects of the method of FIG. 5 may be implemented by a wireless device such as a UE 102 or UE 104 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method of FIG. 5 may operate as follows.

At 501, the UE may request, to the network, an updated configuration for the GNSS measurement gap.

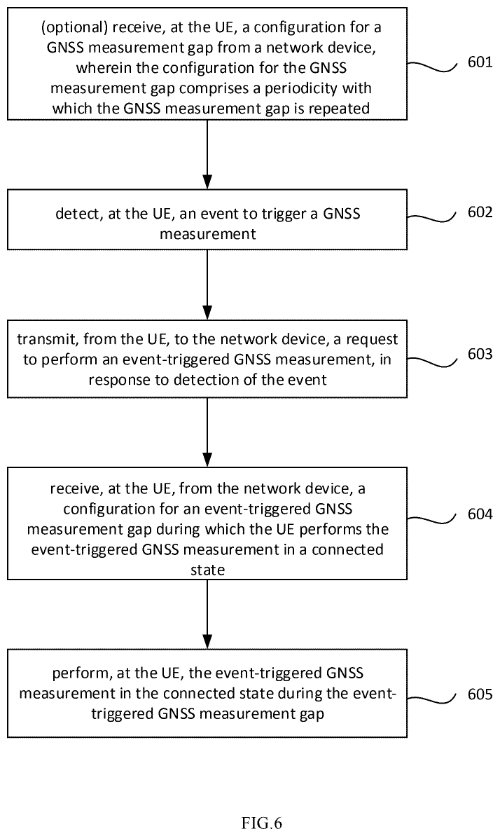

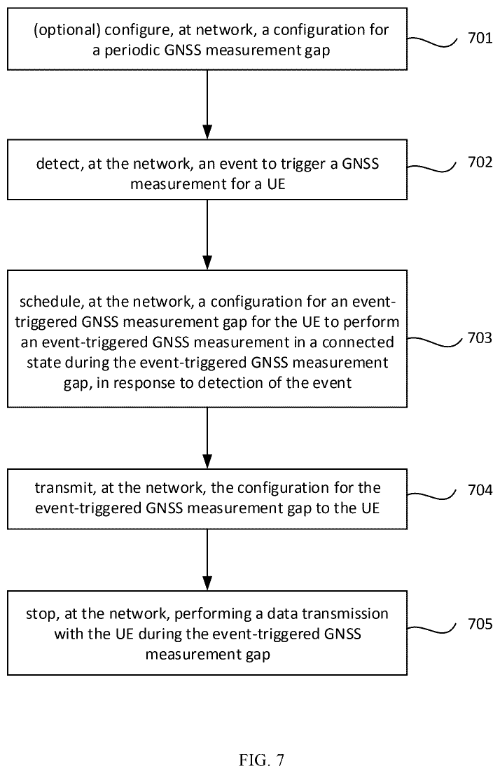

In one aspect, the configuration for the GNSS measurement gap may be modified by the network device, in response to any of the following: mobility information of the UE may be changed; the UE may be farther from a satellite and more GNSS accuracy is required; a data transmission of the UE is overlapped with the GNSS measurement gap; or an aperiodic GNSS measurement occurs and thus a time offset of the GNSS measurement gap needs to be modified. Details of the aperiodic GNSS measurement will be discussed with reference to FIGS. 6-7.

In one aspect, the modification of the configuration for the GNSS measurement gap may be triggered by the UE or the network device. In a case that the modification is triggered by the UE, the updated configuration for the GNSS measurement gap is requested via an RRC signaling.

At 502, the UE may receive, from the network, the updated configuration for the GNSS measurement gap.

In one aspect, the updated configuration for the GNSS measurement gap may be received via an RRC signaling. In one aspect, the updated configuration for the GNSS measurement gap may include any of: a starting time offset of a next GNSS measurement gap, an updated GNSS measurement gap duration, or an updated periodicity of the GNSS measurement gap with which the GNSS measurement is repeated.

At 503, the UE may perform an updated GNSS measurement in the connected state during the updated GNSS measurement gap. In one example, the UE may perform the GNSS measurement based on the updated configuration for the GNSS measurement gap.

In addition to configuring a periodic GNSS measurement, an event at either the UE side or the network side may trigger an aperiodic GNSS measurement.

FIG. 6 is a flowchart diagram illustrating an example method for performing an event-triggered GNSS measurement, by a UE, according to embodiments disclosed herein. Aspects of the method of FIG. 6 may be implemented by a wireless device such as a UE 102 or UE 104 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method of FIG. 6 may operate as follows.

At 601, which may be optional, the UE may receive, a configuration for the GNSS measurement gap from the network device, wherein the configuration for the GNSS measurement gap comprises a periodicity with which the GNSS measurement gap is repeated. The operation 601 may be similar to the operation 402 of FIG. 4, and thus will not be described for concision.

Correspondingly, at the network side, the network device may configure the configuration for the GNSS measurement gap comprising the periodicity.

At 602, the UE may detect an event to trigger a GNSS measurement.

In one aspect, the event to trigger the GNSS measurement is a first event which includes: a movement of the UE is larger than a first threshold. In some aspects, the first threshold may be configured by the network device to the UE via an RRC signaling or a System Information Block (SIB).

In one example, the first threshold may depend on an elevation angle of the UE. The first threshold may be larger for a larger elevation angle. For example, the first threshold may be positively related to the elevation angle. For a large elevation angle, the first threshold may be large, while for a small elevation angle, the first threshold may be small.

In another example, the first threshold may depend on a UE specific timing offset K_{offset} configured by the network device. For example, the first threshold may be negatively related to the timing offset K_{offset}. For a large timing offset K_{offset}, the first threshold may be small, while for a small timing offset K_{offset}, the first threshold may be large.

In another aspect, the event to trigger the GNSS measurement is a second event which includes any of: a number of TA commands received by the UE within a time window is larger than a second threshold, or an accumulated value of timing advance values indicated in all the TA commands received by the UE within the time window is larger than a third threshold. The time window may be configured by the network device to the UE via an RRC signaling or a SIB.

In one example, if the UE receives more than 10 TA commands, in case the second threshold may be 8, the second event occurs.

In another example, if the UE receives a series of TA commands with values of 2 ms, 4 ms, 5 ms, . . . , and the accumulation of these values are larger than a third threshold of 10 ms, the second event occurs.

In yet another aspect, the event to trigger the GNSS measurement is a third event which includes: a time difference between the time of detection of the first event or the second event above and a next periodic GNSS measurement gap is larger than a fourth threshold. In some aspects, the fourth threshold may be configured by the network device or pre-defined.

At 603, the UE may transmit, to the network device, a request to perform an event-triggered GNSS measurement, in response to detection of any of the above events.

In some aspects, the request may be transmitted via any of the following: an RRC signaling; a dedicated Medium Access Control (MAC) Control Element (CE) designed for the request; or periodic Schedule Request (SR) resources with a different cyclic shift for the request over a Physical Uplink Control Channel (PUCCH).

In some aspects, the request may include: an event-triggered GNSS measurement gap duration and an upper bound on the event-triggered GNSS measurement gap timing.

The event-triggered GNSS measurement gap duration may be represented in units of seconds, milli-seconds, frames or subframes; or may be represented by an entry index of a GNSS measurement gap duration table which lists a plurality of GNSS measurement gap durations in units of seconds, milli-seconds, frames or subframes.

The upper bound represents before what time the event-triggered GNSS measurement gap has to be scheduled. In one aspect, the upper bound may indicate a starting time or an ending time of the event-triggered GNSS measurement gap. In one aspect, the upper bound may be represented by a system frame number (SFN) and/or a subframe index that indicates a nearest future SFN and/or a subframe index for the event-triggered GNSS measurement gap.

At the network side, the network device may receive, from the UE, the request of performing the event-triggered GNSS measurement.

At the network side, the network device may schedule a configuration for an event-triggered GNSS measurement gap for the UE to perform the measurement.

At 604, the UE may receive, from the network device, a configuration for an event-triggered GNSS measurement gap during which the UE performs the event-triggered GNSS measurement in a connected state.

In some aspects, the configuration for the event-triggered GNSS measurement gap may be received via any of the following: an RRC signaling; a dedicated MAC CE designed for the configuration; or a Downlink Control Information (DCI) message.

In some aspects, the configuration for the event-triggered GNSS measurement gap may include: an event-triggered GNSS measurement gap duration and a starting time of the event-triggered GNSS measurement gap.

The event-triggered GNSS measurement gap duration may be represented in units of seconds, milli-seconds, frames or subframes; or may be represented by an entry index of a GNSS measurement gap duration table which lists a plurality of GNSS measurement gap durations in units of seconds, milli-seconds, frames or subframes.

The starting time of the event-triggered GNSS measurement gap may be represented by a SFN and/or a subframe index that indicates a nearest future SFN and/or a subframe index for the event-triggered GNSS measurement gap.

At 605, the UE may perform the event-triggered GNSS measurement in the connected state during the event-triggered GNSS measurement gap.

The method may further comprise that the UE may stop performing a data transmission with the network device during the event-triggered GNSS measurement gap. At the network side, the network device may stop scheduling data transmissions to/from the UE during the event-triggered GNSS measurement gap.

As described above, an event at the network side may also trigger an aperiodic GNSS measurement.

FIG. 7 is a flowchart diagram illustrating an example method for performing an event-triggered GNSS measurement, by a network device, according to embodiments disclosed herein. Aspects of the method of FIG. 7 may be implemented by a network device such as a base station 112 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method of FIG. 7 may operate as follows.

At 701, which may be optional, the network device may configure, a configuration for a periodic GNSS measurement gap, that is, a configuration for a GNSS measurement gap comprising a periodicity with which the GNSS measurement gap is repeated.

Accordingly, at the UE side, which may be optional, the UE may receive the configuration for the GNSS measurement gap from the network device.

At 702, the network device may detect an event to trigger a GNSS measurement for the UE.

In one aspect, the event to trigger the GNSS measurement is a first event which includes: a number of TA commands transmitted by the network device within a time window is larger than a fifth threshold, or an accumulated value of timing advance values indicated in all the TA commands transmitted by the network device within the time window is larger than a sixth threshold. The time window may be configured by the network device.

In another aspect, the event to trigger the GNSS measurement is a second event which includes: a time difference between detection of the first event and a next periodic GNSS measurement gap is larger than a seventh threshold. In some aspects, the seventh threshold may be configured by the network device or pre-defined.

At 703, the network device may schedule a configuration for an event-triggered GNSS measurement gap for the UE to perform an event-triggered GNSS measurement in a connected state during the event-triggered GNSS measurement gap, in response to detection of the event.

At 704, the network device may transmit the configuration for the event-triggered GNSS measurement gap to the UE. The operation 704 may be performed in combination with the operation 703, that is, the network device may schedule and transmit the configuration to the UE. Correspondingly, at the UE side, the UE may receive the configuration, and perform the event-triggered GNSS measurement gap during the event-triggered GNSS measurement gap.

In one aspect, the configuration for the event-triggered GNSS measurement gap transmitted by the network device may include an event-triggered GNSS measurement gap duration, and a starting time of the event-triggered GNSS measurement gap. In one aspect, the event-triggered GNSS measurement gap duration and the starting time of the event-triggered GNSS measurement gap may depend on a GNSS measurement gap duration and/or an existing GNSS validity duration X that has been reported by the UE.

The method may further comprise that the network device may stop scheduling or performing a data transmission to/from the UE during the event-triggered GNSS measurement gap.

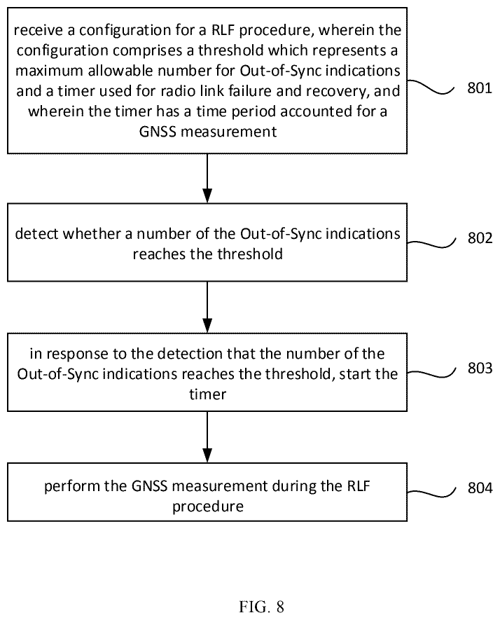

FIG. 8 is a flowchart diagram illustrating an example method for performing a GNSS measurement in RLF procedure, by a UE, according to embodiments disclosed herein. Aspects of the method of FIG. 8 may be implemented by a wireless device such as a UE 102 or UE 104 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method of FIG. 8 may operate as follows.

At 801, the UE may receive a configuration for the RLF procedure. In one aspect, the configuration may comprise a threshold which represents a maximum allowable number for Out-of-Sync indications and a timer used for radio link failure and recovery. In one aspect, the timer may have a time period accounted for the GNSS measurement.

For example, the threshold may be a parameter of N310 for the RLF procedure, the timer may be an extended T310 timer for performing a GNSS measurement during the RLF procedure.

In one aspect, the timer may be an extended T310 timer and the extended T310 timer may be generated by adding an offset used for the GNSS measurement to an Information Element (IE) associated with a T310 timer, for example, an IE of “RLF-TimersAndConstants”. In one aspect, the offset may depend on a GNSS measurement gap reported by the UE.

In another aspect, the timer may be an extended T310 timer and the extended T310 timer may be generated by extending one or more candidate values enough for the GNSS measurement in the IE associated with the T310 timer, for example, an IE of “RLF-TimersAndConstants”. For example, current largest value of “RLF-TimersAndConstants” may be 6000 ms, which may not be enough for GNSS measurement, therefore, for the GNSS measurement, candidate values of 10000 ms and 20000 ms may be extended into the IE.

In yet another aspect, the timer may be an extended T310 timer and the extended T310 timer may be generated by defining a configuration for the GNSS measurement in a GNSS related IE associated with the T310 timer, for example, an IE named as “RLF TimersAndConstants GNSS”.

At 802, the UE may detect whether a number of the Out-of-Sync indications reaches the threshold.

At 803, in response to the detection that the number of the Out-of-Sync indications reaches the threshold, the UE may start the timer. For example, in response to a detection that having the Out-of-Sync indications for N310 times, the UE may start the timer for the RLF procedure.

At 804, the UE may perform the GNSS measurement during the RLF procedure.

The method may further comprise that the UE may determine whether to move to an IDLE mode within the extended T310 timer or not depending on a reception of an In-Sync indication. For example, in response to receipt of an indication of In-Sync for N311 times within the extended T310 timer, the UE may go to the IDLE mode.

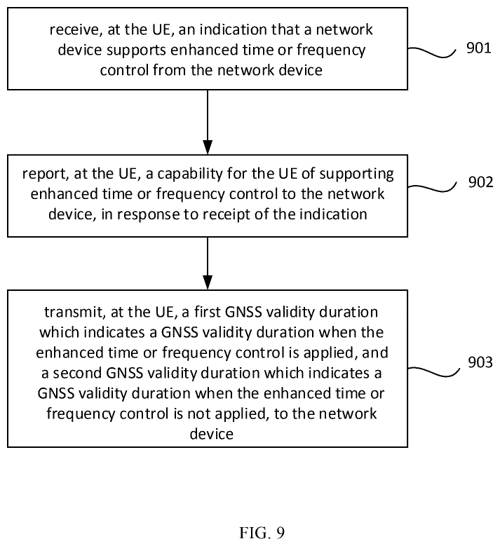

FIG. 9 is a flowchart diagram illustrating an example method for a GNSS measurement in enhanced time or frequency control, by a UE, according to embodiments disclosed herein. Aspects of the method of FIG. 9 may be implemented by a wireless device such as a UE 102 or UE 104 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method of FIG. 9 may operate as follows.

At 901, the UE may receive an indication that the network device supports enhanced time or frequency control from the network device.

In one aspect, enhanced time control may include any of: a TA drift, or a TA drift variation parameter from the network device. Enhanced frequency control may include any of: a frequency offset over time, a frequency drift, or a frequency drift variation parameter from the network device.

In one aspect, enablement or disablement of the enhanced time or frequency control may be configured by the network device.

At 902, the UE may report a capability of the UE for supporting enhanced time or frequency control to the network device, in response to receipt of the indication.

At 903, the UE may transmit, to the network device, a first GNSS validity duration which indicates a GNSS validity duration when the enhanced time or frequency control is applied, and a second GNSS validity duration which indicates a GNSS validity duration when the enhanced time or frequency control is not applied.

In one aspect, the first GNSS validity duration may be longer than the second GNSS validity duration. For example, the first GNSS validity duration may be 1 minute, while the second GNSS validity duration may be 10 seconds. Therefore, for the enhanced time or frequency control, the GNSS position fix may be valid for longer time, which may be useful for long connection times.

The method may further comprise that the network device may correspondingly send enhanced time or frequency closed loop control to the UE, and the UE may receive, enhanced time or frequency control which corresponds to its reported capability, from the network device.

The method may further comprise that the UE may adjust an uplink data or control transmission time and frequency based on the received enhanced time or frequency control from the network device, depending on its reported capability.

Embodiments contemplated herein include an apparatus comprising means to perform one or more elements of the methods as above. This apparatus may be, for example, an apparatus of a UE (such as a wireless device 202 that is a UE, as described herein).

Embodiments contemplated herein include one or more non-transitory computer-

readable media comprising instructions to cause an electronic device, upon execution of the instructions by one or more processors of the electronic device, to perform one or more elements of the methods as above. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method s as above. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the methods as above. This apparatus may be, for example, an apparatus of a UE (such as a wireless device 202 that is a UE, as described herein).

Embodiments contemplated herein include a signal as described in or related to one or more elements of the methods as above.

Embodiments contemplated herein include a computer program or computer program product comprising instructions, wherein execution of the program by a processor is to cause the processor to carry out one or more elements of the methods as above. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the methods as above. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the methods as above. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the methods as above. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the methods as above. This apparatus may be, for example, an apparatus of a base station (such as a network device 218 that is a base station, as described herein).

Embodiments contemplated herein include a signal as described in or related to one or more elements of the methods as above.

Embodiments contemplated herein include a computer program or computer program product comprising instructions, wherein execution of the program by a processing element is to cause the processing element to carry out one or more elements of the methods as above. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A User Equipment (UE), comprising:
at least one antenna;
at least one radio, configured to perform wireless communication using at least one radio access technology; and
one or more processors coupled to the at least one radio, wherein the at least one radio and the one or more processors are configured to cause the UE to:
detect an event to trigger a Global Navigation Satellite System (GNSS) measurement;
transmit, to a network device, a request to perform an event-triggered GNSS measurement, in response to detection of the event;
receive, from the network device, a configuration for an event-triggered GNSS measurement gap during which the UE performs the event-triggered GNSS measurement in a connected state; and
perform the event-triggered GNSS measurement in the connected state during the event-triggered GNSS measurement gap.

2. The UE of claim 1, wherein the event to trigger the GNSS measurement is a first event, wherein the first event includes: a movement of the UE is larger than a first threshold.

3. The UE of claim 2, wherein the first threshold depends on any of:
an elevation angle of the UE, or
a UE specific timing offset K_{offset} configured by the network device,
wherein the first threshold is configured by the network device to the UE via a Radio Resource Control (RRC) signaling or a System Information Block (SIB).

4. The UE of claim 1, wherein the event to trigger the GNSS measurement is a second event, wherein the second event includes any of:
a number of timing advance (TA) commands received by the UE within a time window is larger than a second threshold, or
an accumulated value of timing advance values indicated in all the TA commands received by the UE within the time window is larger than a third threshold,
wherein the time window is configured by the network device to the UE via a Radio Resource Control (RRC) signaling or a System Information Block (SIB).

5. The UE of claim 4, wherein the event to trigger the GNSS measurement is a third event, wherein the third event includes:
a time difference between detection of a first event or the second event and a next periodic GNSS measurement gap is larger than a fourth threshold;
wherein the fourth threshold is configured by the network device or pre-defined.

6. The UE of claim 1, wherein the request is transmitted via:
a dedicated Medium Access Control (MAC) Control Element (CE) designed for the request;

7. The UE of claim 1, wherein the request includes:
an event-triggered GNSS measurement gap duration, which is represented in units of seconds.

8. The UE of claim 1, wherein the configuration for the event-triggered GNSS measurement gap is received via any of:
a Radio Resource Control (RRC) signaling;
a dedicated Medium Access Control (MAC) Control Element (CE) designed for the configuration; or
a Downlink Control Information (DCI) message.

9. The UE of claim 1, wherein the configuration for the event-triggered GNSS measurement gap includes:
an event-triggered GNSS measurement gap duration, which is represented: i) in units of seconds, milli-seconds, frames or subframes; or ii) by an entry index of a GNSS measurement gap duration table which lists a plurality of GNSS measurement gap durations in units of seconds, milli-seconds, frames or subframes; and
a starting time of the event-triggered GNSS measurement gap, which is represented by a system frame number (SFN) and/or a subframe index that indicates a nearest future SFN and/or a subframe index for the event-triggered GNSS measurement gap.

10. The UE of claim 1, wherein the at least one radio and the one or more processors are further configured to cause the UE to stop performing a data transmission with the network device during the event-triggered GNSS measurement gap.

11. A network device, comprising:
at least one antenna;
at least one radio, configured to perform wireless communication using at least one radio access technology; and
one or more processors coupled to the at least one radio, wherein the at least one radio and the one or more processors are configured to cause the network device to:
detect an event to trigger a Global Navigation Satellite System (GNSS) measurement for a User Equipment (UE);
schedule a configuration for an event-triggered GNSS measurement gap for the UE to perform an event-triggered GNSS measurement in a connected state during the event-triggered GNSS measurement gap, in response to detection of the event; and
transmit the configuration for the event-triggered GNSS measurement gap to the UE.

12. The network device of claim 11, wherein the event to trigger the GNSS measurement is a first event, wherein the first event includes:
a number of timing advance (TA) commands transmitted by the network device within a time window is larger than a fifth threshold, or
an accumulated value of timing advance values indicated in all the TA commands transmitted by the network device within the time window is larger than a sixth threshold,
wherein the time window is configured by the network device.

13. The network device of claim 11, wherein the event to trigger the GNSS measurement is a second event, wherein the second event includes:
a time difference between detection of a first event and a next periodic GNSS measurement gap is larger than a seventh threshold;
wherein the seventh threshold is configured by the network device or pre-defined.

14. The network device of claim 11, wherein the configuration for the event-triggered GNSS measurement gap transmitted by the network device includes:
an event-triggered GNSS measurement gap duration, and a starting time of the event-triggered GNSS measurement gap,
wherein the event-triggered GNSS measurement gap duration and the starting time of the event-triggered GNSS measurement gap depend on a GNSS measurement gap duration and/or a GNSS validity duration reported by the UE.

15. The network device of claim 11, wherein the at least one radio and the one or more processors are further configured to cause the network device to stop performing a data transmission with the UE during the event-triggered GNSS measurement gap.

16. A non-transitory computer readable memory medium storing program instructions executable by one or more processors to cause a User Equipment (UE) to:
detect an event to trigger a Global Navigation Satellite System (GNSS) measurement;
transmit, to a network device, a request to perform an event-triggered GNSS measurement, in response to detection of the event;
receive, from the network device, a configuration for an event-triggered GNSS measurement gap during which the UE performs the event-triggered GNSS measurement in a connected state; and
perform the event-triggered GNSS measurement in the connected state during the event-triggered GNSS measurement gap.

17. The non-transitory computer readable memory medium of claim 16, wherein the event to trigger the GNSS measurement is a first event, wherein the first event includes: a movement of the UE is larger than a first threshold, and wherein the first threshold depends on any of:
an elevation angle of the UE, or
a UE specific timing offset K_{offset} configured by the network device,
wherein the first threshold is configured by the network device to the UE via a Radio Resource Control (RRC) signaling or a System Information Block (SIB).

18. The non-transitory computer readable memory medium of claim 17, wherein the event to trigger the GNSS measurement is a second event, wherein the second event includes any of:
a number of timing advance (TA) commands received by the UE within a time window is larger than a second threshold, or
an accumulated value of timing advance values indicated in all the TA commands received by the UE within the time window is larger than a third threshold,
wherein the time window is configured by the network device to the UE via a Radio Resource Control (RRC) signaling or a System Information Block (SIB).

19. The non-transitory computer readable memory medium of claim 18, wherein the event to trigger the GNSS measurement is a third event, wherein the third event includes:
a time difference between detection of the first event or the second event and a next periodic GNSS measurement gap is larger than a fourth threshold;
wherein the fourth threshold is configured by the network device or pre-defined.

20-24. (canceled)

25. The UE of claim 1, wherein the request is transmitted via a dedicated Medium Access Control (MAC) Control Element (CE) and includes an event-triggered GNSS measurement gap duration represented by an entry index of a GNSS measurement gap duration table which lists a plurality of GNSS measurement gap durations in units of seconds.
